(19) United States
(12) Patent Application Publication
(10) Pub. No.: US 2005/0069739 A1
(43) Pub. Date: Mar. 31, 2005

(54) Battery unit and power supply control method

(76) Inventors: Akihiro Ozeki, Ome-shi (JP); Koji Nakamura, Akiruno-shi (JP); Nobou Shibuya, Hiratsuka-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/947,932

(22) Filed: Sep. 23, 2004

(30) Foreign Application Priority Data
Sep. 30, 2003 (JP) 2003-342329

(51) Int. Cl. H01M 8/04

(52) U.S. Cl. 429/22; 429/13

(57) ABSTRACT

According to the embodiment, battery unit includes a fuel cell capable of generating power by chemical reaction, a first switch positioned between an output terminal of the fuel cell and a load, a second switch and a resistor arranged in series between the output terminal of the fuel cell and a ground, and a control unit. The central unit places the first switch and the second switch into a connected state for a predetermined period of time in a warm-up processing of the fuel cell.

### CROSS-REFERENCE TO RELATED APPLICATIONS

This application is based upon and claims the benefit of priority from prior Japanese Patent Application No. 2003-342329, filed Sep. 30, 2003, the entire contents of which are incorporated herein by reference.

### BACKGROUND

1. Field

Embodiments of the present invention relate to a battery unit having a direct methanol fuel cell and a power supply control method.

2. Description of the Related Art

Recently, portable electronic devices of various types such as a digital camera and a portable information terminal called a PDA (personal digital assistant) have been developed and widely used. The electronic device can be driven by a battery.

Moreover, recently, environmental issues have received great attention and the development of environmentally friendly batteries has been increased. A direct methanol fuel cell (hereinafter referred to as “DMFC”) is well known as such a battery.

A DMFC generates electric energy by chemical reaction between oxygen and methanol provided as fuel. The DMFC has a structure in which an electrolyte is interposed between two electrodes made of porous metal or carbon. Since the DMFC produces no hazardous wastes, its practicality is strongly desired.

Some DMFCs include an auxiliary machine such as a liquid-sending/air-blowing pump in order to increase the output per unit area (volume). This type of DMFC generally has a secondary battery such as a lithium battery because the auxiliary machine needs to be driven when the DMFC starts up.

The DMFC is disclosed in, for example, K. Ikeda, “Outline of Fuel Cell,” Nippon Jitsugyo Publishing Co., Ltd., Aug. 20, 2001, pp. 216-217.

When a plurality of fuel cells are stacked in a DMFC, they need to be built with high withstand-voltage components because their voltage increases at no load. However, the high withstand-voltage components are generally expensive. The higher the withstand voltage of components of the same size in a capacitor, the smaller the capacity of the capacitor.

It is known that the impedance of a DMFC is very high and the DMFC requires a large capacity to cope with a sudden change in load. If a large capacity is required, the DMFC will increase in costs and components.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external view of an electronic system according to an embodiment of the present invention;

FIG. 2 is an exemplary embodiment of a schematic block diagram of a fuel cell unit;

FIG. 3 is an exemplary embodiment of a schematic block diagram of a fuel circulation mechanism of the fuel cell unit;

FIG. 4 is an exemplary embodiment of a schematic block diagram of an electronic device;

FIG. 5 is an exemplary embodiment of a graph of voltage to current characteristics of a unit cell in a DMFC;

FIG. 6 is an exemplary embodiment of a block diagram of power supply control of a DMFC cell stack; and

FIG. 7 is an exemplary embodiment of a chart showing a sequence of power supply control of the DMFC cell stack.

### DETAILED DESCRIPTION

Embodiments of the present invention will be described below with reference to the drawings. In general, embodiments of the present invention provide a battery unit that handles voltage increases at no load, and a power supply control method.

For instance, according to one embodiment of the present invention, a battery unit comprises a fuel cell capable of generating power by chemical reaction; a first switch provided between an output terminal of the fuel cell and a load; a second switch and a resistor arranged in series between the output terminal of the fuel cell and a ground; and a control unit which brings the first switch and the second switch into a connected state for a fixed period of time in a warm-up processing of the fuel cell.

According to another embodiment of the present invention, a power supply control method in a fuel cell is provided for generating power by chemical reaction. The method comprises providing a first switch between an output terminal of the fuel cell and a load and arranging a second switch and a resistor in series between the output terminal of the fuel cell and a ground. The first switch and the second switch are brought into a connected state for a fixed period of time in a warm-up processing of the fuel cell.

I. General Architecture

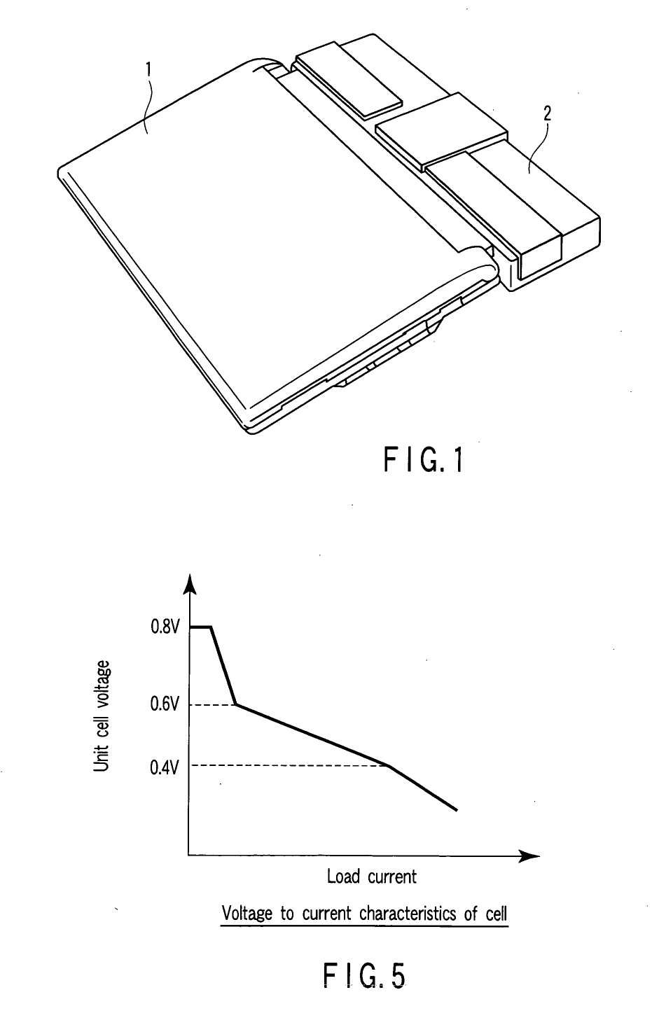

FIG. 1 is an external view of an electronic system according to an embodiment of the present invention.

Referring to FIG. 1, the electronic system includes an electronic device 1 and a fuel cell unit 2 that is detachable from the electronic device 1. The electronic device 1 is a notebook personal computer in which a top cover having an LCD (liquid crystal display) on its inner side is attached to the main unit by a hinge mechanism such that it can freely be opened and closed. The electronic device 1 can be operated by power supplied from the fuel cell unit 2. The fuel cell unit 2 includes a direct methanol fuel cell (DMFC) capable of generating power by chemical reaction and a repeatedly chargeable/dischargeable secondary battery.

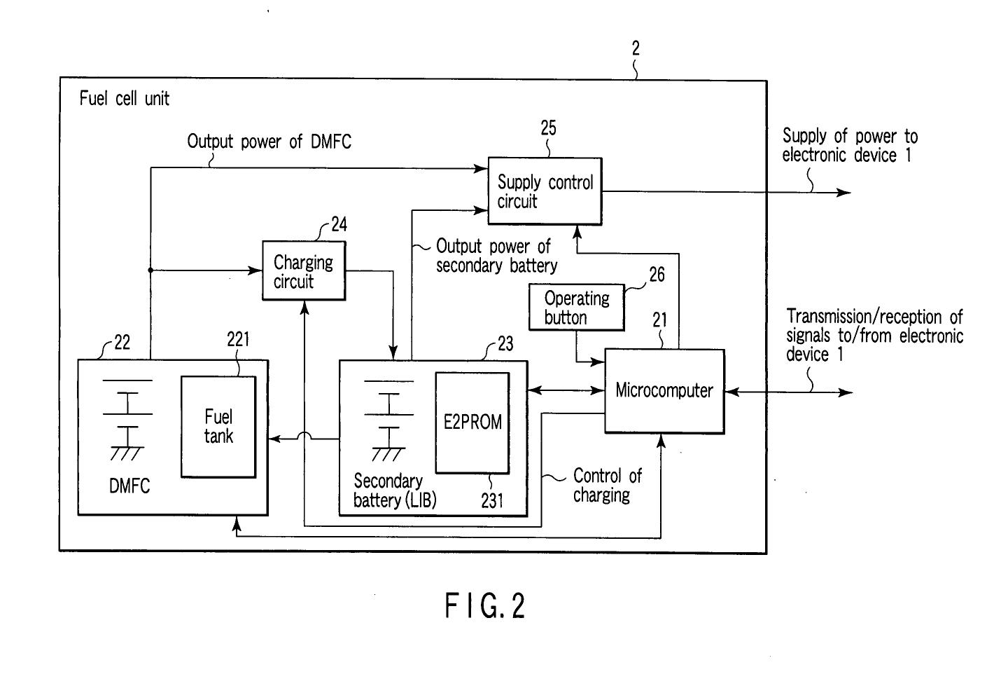

FIG. 2 is an exemplary embodiment of a schematic block diagram of the fuel cell unit 2.

Referring to FIG. 2, the fuel cell unit 2 includes a microcomputer 21, a DMFC 22, a secondary battery 23, a charging circuit 24, a supply control circuit 25 and an operating button 26.

The microcomputer 21 controls the entire operation of the fuel cell unit 2 and has a communication function of transmitting/receiving signals to/from the electronic device 1. The microcomputer 21 controls the operations of the DMFC 22 and secondary battery 23 in response to a signal from the electronic device 1, and performs a process corresponding to the depression of the operating button 26.

The DMFC 22 includes a detachable cartridge fuel tank 221 and outputs power that is generated by chemical reaction between air (oxygen) and methanol stored in the fuel tank 221. The chemical reaction occurs in a reaction section referred to as a cell stack or the like. In order to send the methanol and air into the cell stack with efficiency, the DMFC 22 has an auxiliary mechanism such as a pump. The DMFC 22 also has a mechanism to notify the microcomputer 21 of the attachment or detachment of the fuel tank 221, the amount of methanol remaining in the fuel tank 221, the operating status of the auxiliary mechanism, and the present amount of output power.

The secondary battery 23 stores power output from the DMFC 22 through the charging circuit 24 and outputs the power in response to the indication from the microcomputer 21. The secondary battery 23 has non-volatile memory (e.g., an EEPROM 231) that holds basic information indicative of discharge characteristics and the like. The EEPROM 231 can be accessed from the microcomputer 21. The secondary battery 23 has a mechanism to notify the microcomputer 21 of both the present output voltage value and the present output current value. The microcomputer 21 computes the amount of power remaining in the secondary battery 23 based on both the basic information read out of the EEPROM 231 and the output voltage and current values indicated by the secondary battery 23. The microcomputer then notifies the electronic device 1 of the computed amount. According to one embodiment of the invention, the secondary battery 23 may be a lithium battery (LIB), but is not restricted to this type of battery.

The charging circuit 24 charges the secondary battery 23 with power output from the DMFC 22. The microcomputer 21 controls whether the secondary battery 23 is charged or not.

The supply control circuit 25 outputs the power of the DMFC 22 and secondary battery 23 to the electronic device 1 according to a variety of factors associated with the operating environment such as the amount of power needed, temperature, etc.

The operating button 26 is an optional, dedicated button to give an instruction to stop the entire operation of the DMFC 22 or the fuel cell unit 2. The same function as that of the operating button 26 can be fulfilled by a button presented by the application on the LCD screen of the electronic device 1 or by depressing a power supply button of the electronic device 1 for a long time (depressing it longer than a given period of time).

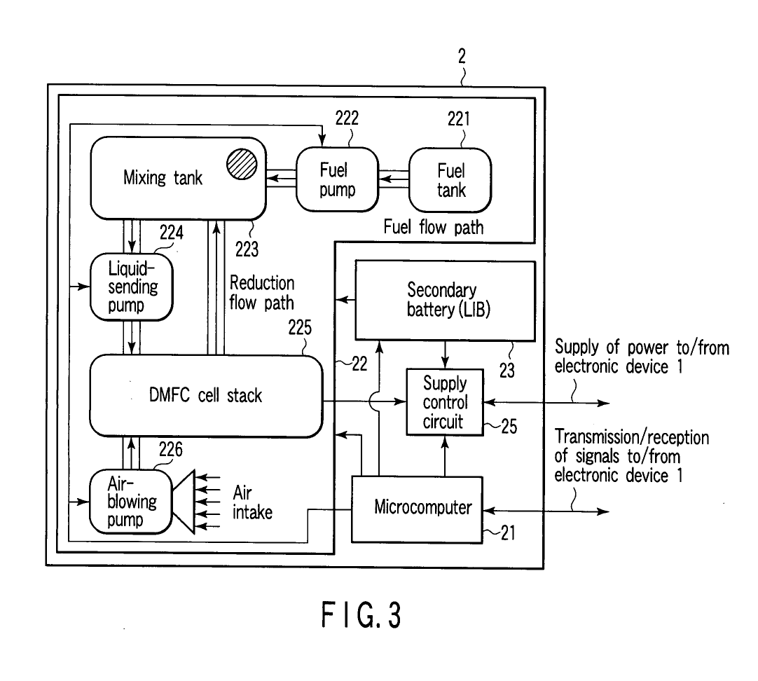

FIG. 3 is an exemplary embodiment of a block diagram of a fuel circulation mechanism of the fuel cell unit 2. The components that correspond to those of FIG. 2 are denoted by the same reference numerals.

Referring to FIG. 3, the DMFC 22 includes a fuel tank 221, a fuel pump 222, a mixing tank 223, a liquid-sending pump 224, a DMFC cell stack 225 and an air-blowing pump 226.

The methanol in the fuel tank 221 is supplied to the mixing tank 223 by the fuel pump 222 and diluted. The diluted methanol is sent into the DMFC cell stack 225 by the liquid-sending pump 224. Air is sent into the DMFC cell stack 225 by the air-blowing pump 226, and an aqueous solution of the diluted methanol reacts to oxygen in the air to generate power.

The microcomputer 21 controls an auxiliary machine such as the fuel pump 222, liquid-sending pump 224, air-blowing pump 226 and fan by the power of the secondary battery 23 in response to a startup indicating signal transmitted from the electronic device 1. The microcomputer 21 controls the supply control circuit 25 such that the electronic device 1 is supplied with power from the DMFC cell stack 225 and/or the secondary battery 23. The microcomputer 21 also controls charging of the secondary battery 23 before the DMFC 22 stops in response to a stop indicating signal sent from the electronic device 1.

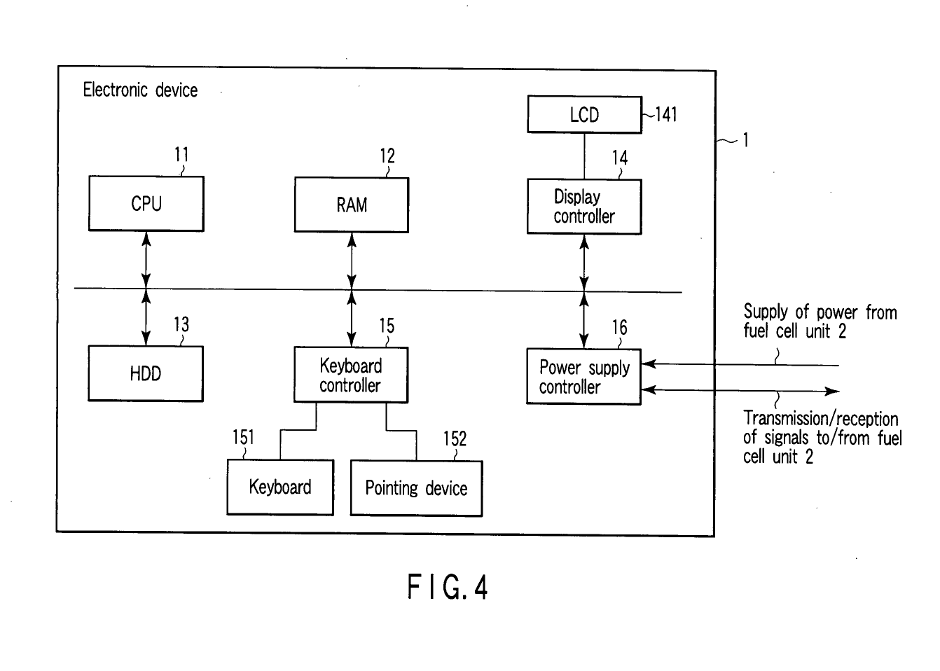

FIG. 4 is an exemplary embodiment of schematic block diagram of the electronic device 1.

Referring to FIG. 4, the electronic device 1 includes a CPU 11, a main memory (e.g., random access memory “RAM” 12, a hard disk drive (HDD) 13, a display controller 14, a keyboard controller 15 and a power supply controller 16. These are connected to a system bus.

The CPU 11 controls the entire operation of the electronic device 1 and executes various programs stored in the RAM 12. The RAM 12 is a memory device serving as a main memory of the electronic device 1 to store various programs to be executed by the CPU 11 and various items of data to be used for the programs. The HDD 13 is a memory device serving as an external memory of the electronic device 1 and an auxiliary device of the RAM 12 to store various programs and a large amount of data.

The display controller 14 controls the output side of a user interface in the electronic device 1 and displays image data created by the CPU 11 on an LCD 141. The keyboard controller 15 controls the input side of the user interface in the electronic device 1. The controller 15 converts the operations of a keyboard 151 and a pointing device 152 into electrical data and supplies this data to the CPU 11 via a register included therein.

The power supply controller 16 controls the supply of power to the respective components of the electronic device 1. The controller 16 has a power-receiving function of receiving power from the fuel cell unit 2 and a communication function of transmitting/receiving signals to/from the fuel cell unit 2. It is the microcomputer 21 in the fuel cell unit 2 shown in FIGS. 2 and 3 that transmits/receives signals to/from the power supply controller 16.

II. Voltage to Current Characteristics of Cell

FIG. 5 is an exemplary embodiment of a graph of voltage to current characteristics of a unit cell in the DMFC 22 described above.

As is seen from the graph, the voltage of the unit cell operated at no load is about 0.8 volts (V) and that of the unit cell operated in a steady state is about 0.4V, and the former is two or more times as high as the latter. A plurality of fuel cell units are usually stacked and thus their voltages increase when they operate at no load. If twenty fuel cells are stacked, their voltages become about 8V while the electronic device 1 is operating, but about 16V or higher at no load, thus requiring high withstand-voltage components.

However, the high withstand-voltage components generally increase the total cost of the electronic device. If a capacitor is made up of higher withstand-voltage components of the same size, its capacity will decrease. Further, large capacitive components are required for coping with a sudden change in load; however, the cost and the area of the components will increase. The present embodiment thus provides a method of controlling the supply of power in order to resolve the above problem.

III. Circuit Arrangement for Power Supply Control

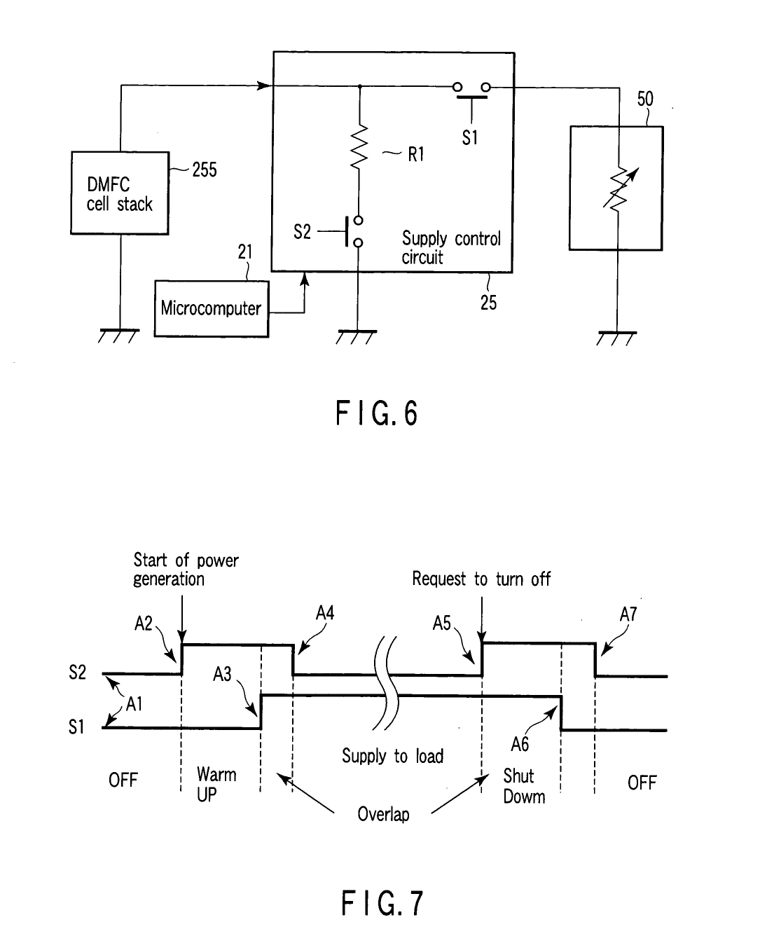

FIG. 6 shows an exemplary embodiment of a circuit arrangement for power supply control of the DMFC cell stack 225. Herein, the same components as those of FIGS. 1 to 3 are denoted by the same reference numerals. A load 50 corresponds to the electronic device 1 described above.

The supply control circuit 25 includes a first open/close switch S1, a second open/close switch S2 and an impedance element (e.g., resistor R1). The switch S1 is provided between an output terminal of the DMFC cell stack 225 and the load 50. The switch S2 and resistor R1 are arranged in series between the output terminal of the DMFC cell stack 225 and the ground.

The microcomputer 21 selectively controls the switches S1 and S2 in a given sequence. In a warm-up processing of the DMFC cell stack 225, the microcomputer 21 brings both the switches S1 and S2 into a connected (closed) state for a given period of time. In a steady state operation of the DMFC cell stack 225, the microcomputer 21 brings the switch S2 into a non-connected (open) state. In a shutdown processing of the DMFC cell stack 225, the microcomputer 21 brings both the switches S1 and S2 into a connected (closed) state for a given period of time. When the DMFC cell stack 225 stops, the microcomputer 21 brings both the switches S1 and S2 into a non-connected (open) state.

The arrangement shown in FIG. 6 includes a resistor R1 to draw part of output current of the DMFC cell stack 225 into the ground. According to one embodiment for the voltage to current characteristics of the DMFC, in general, the voltage suddenly drops to about 0.6V when the amount of current to the load decreases. In other words, the voltage can be prevented from increasing if the current that is one-tenth of the maximum load is drawn into the ground by the resistor R1. However, a loss of power due to the resistor R1 causes a problem when power is applied to the load. In order to prevent the loss of power, the switch S2 is provided to stop drawing the current when power is applied.

IV. Sequence of Power Supply Control

FIG. 7 shows an exemplary embodiment of a sequence of power supply control of the DMFC cell stack 225.

When the DMFC cell stack 225 is not in operation (stop state), both the switches S1 and S2 are brought into non-connected state (event A1).

Upon receiving a request to start generating power, the DMFC cell stack 225 starts to warm up in order to apply power to a load. First, the switch S2 changes from its non-connected state to a connected state (event A2). After a given period of time has elapsed, the switch S1 changes from its non-connected state to a connected state (event A3). Thus, power starts to be applied to the load. The time interval between events A2 and A3 depends on the concentration of fuel and the penetration of methanol. Both the switches S1 and S2 are brought into a connected state for a fixed time period, and during this time period, the DMFC cell stack 225 is prevented from operating at no load even for a moment. After that, the switch S2 changes from its connected state to a non-connected state (event A4), and the DMFC cell stack 225 goes into a steady state.

Upon receiving a request to stop generating power, the DMFC cell stack 225 starts to shut down in order to stop applying power to the load. First, the switch S2 changes from its non-connected state to a connected state (event A5). Both the switches S1 and S2 are brought into a connected state for a given period of time. After that, the switch S1 changes from its connected state to a non-connected state (event A6), and the supply of power to the load stops. After that, the switch S2 changes from its connected state to a non-connected state (event A7), and the DMFC cell stack 225 goes into a stop state.

The embodiment described above can flexibly resolve the problem in which the DMFC cell stack increases in voltage at no load since part of the output current of the DMFC cell stack can be drawn into the ground in a warm-up processing/shutdown processing of the DMFC cell stack. When power is supplied from the battery unit, a loss of the power can be prevented by stopping the current from being drawn.

As described above in detail, according to the present invention, it is possible to flexibly resolve the problem in which the DMFC cell stack increases in voltage at no load.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A battery unit comprising:
a fuel cell; and
a plurality of switches coupled to an output terminal of the fuel cell; and
a control unit altering a state of the plurality of switches for a predetermined period of time during a warm-up processing of the fuel cell.

2. The battery unit according to claim 1, further comprising a ground and a load coupled to the plurality of switches; wherein the plurality of switches comprises:
a first switch coupled to the output terminal of the fuel cell and the load; and
a second switch arranged between the output terminal of the fuel cell and the ground.

3. The battery unit according to claim 2, wherein the control unit placing both the first switch and the second switch into a connected state for a predetermined period of time during the warm-up processing of the fuel cell.

4. The battery unit according to claim 3, further comprising an impedance element arranged between the output terminal and the second switch.

5. The battery unit according to claim 4, wherein the impedance element is a resistor.

6. The battery unit according to claim 3, wherein the control unit changes the first switch from a non-connected state to a connected state after changing the second switch from a non-connected state to a connected state during the warm-up processing of the fuel cell.

7. The battery unit according to claim 6, wherein the control unit changes the second switch into a non-connected state for a steady state operation of the fuel cell.

8. The battery unit according to claim 3, wherein the control unit places the first switch and the second switch into the connected state for a predetermined period of time during a shutdown processing of the fuel cell.

9. The battery unit according to claim 8, wherein the control unit changes the first switch from the connected state to the non-connected state after changing the second switch from the non-connected state to the connected state during the shutdown processing of the fuel cell.

10. The battery unit according to claim 3, wherein the control unit places the first switch and the second switch into the non-connected state when the fuel cell stops.

11. A power supply control method in a fuel cell capable of generating power by chemical reaction, the method comprising:
providing a first switch between an output terminal of the fuel cell and a load and arranging a second switch between the output terminal of the fuel cell and a ground; and
placing the first switch and the second switch into a connected state for a predetermined period of time during a warm-up processing of the fuel cell.

12. The method according to claim 11, wherein the arranging of the second switch comprises arranging the second switch and a resistor in series between the output terminal and the ground.

13. The method according to claim 11, wherein the placing the first switch and the second switch into the connected state comprises changing the first switch from a non-connected state to a connected state after the second switch is changed from a non-connected state to the connected state during the warm-up processing of the fuel cell.

14. The method according to claim 12, further comprising placing the second switch into a non-connected state for a steady state operation of the fuel cell.

15. The method according to claim 12, further comprising placing the first switch and the second switch into the connected state for a predetermined period of time during a shutdown processing of the fuel cell.

16. The method according to claim 15, wherein the first switch is changed from the connected state to a non-connected state after the second switch is changed from a non-connected state to the connected state during the shutdown processing of the fuel cell.

17. The method according to claim 12, further comprising bringing the first switch and the second switch into a non-connected state when the fuel cell stops.

18. An electronic system comprising:
an electronic device; and
a battery unit detachably coupled to the electronic device, the battery unit comprises a fuel cell,
a first switch couple to an output terminal of the fuel cell and the electric device,
a second switch and an impedance element arranged in series between the output terminal of the fuel cell and a ground, and
a control unit placing the first switch and the second switch in a connected state for a predetermined period of time during a warm-up, programming operation of the fuel cell and a shutdown processing operation of the fuel cell.

19. The electronic signal according to claim 18, which the impedance element of the battery unit is a register.

20. The electronic signal according to claim 18, wherein the control unit of the battery unit is a micro computer.

21. The electronic signal according to claim 18, wherein the control unit of the battery unit changes the first switch for a non-corrected state to the corrected state after changing the second switch from a non-connected state to the connected state during the warm-up processing operation of the fuel cell.

22. The electronic signal according to claim 18, wherein the fuel cell of the battery unit is a direct methanol fuel cell (DMFC) cell stack.
